(19) United States
(12) Patent Application Publication
(10) Pub. No.: US 2026/0285633 A1
(43) Pub. Date: Sep. 24, 2026

(54) Applicator unit, tire building device and method for applying a continuous strip to a drum

(71) Applicant: VMI HOLLAND B.V., EPE (NL)

(72) Inventors: Peter SCHIPPER, EPE (NL); Jan Kornelis GRASHUIS, EPE (NL); Baki KARA, EPE (NL)

(21) Appl. No.: 19/475,345

(22) PCT Filed: Mar. 7, 2024
(86) PCT No.: PCT/NL2024/050111

§ 371 Date: Oct. 14, 2025

(30) Foreign Application Priority Data
Apr. 14, 2023 (NL) 2034576

(51) Int. Cl. B65H 19/28; B29D 30/28

(52) U.S. Cl. CPC B65H 19/28; B29D 30/28; B65H 2404/54; B65H 2406/33; B65H 2801/93

(57) ABSTRACT

Disclosed is an applicator unit, a tire building device and a method for applying a continuous strip to a drum, wherein the applicator unit has an applicator roll with a roller body that is rotatable about a roll axis and that defines a retaining surface extending in a circumferential direction about the roll axis, wherein the applicator unit further has a retaining member for retaining the continuous strip in a retaining position on the retaining surface, wherein the retaining member is arranged for following the continuous strip in the retaining position on the retaining surface along a retaining arc of at least ten degrees about the roll axis as the roller body rotates about said roll axis.

### BACKGROUND

The invention relates to an applicator unit, a tire building device and a method for applying a continuous strip to a drum.

WO 2022/177421 A1 discloses an applicator unit, a tire building device and a method for applying a continuous length of a strip to a drum, wherein the applicator unit comprises an applicator roller with a roller body that is rotatable about a roller axis for applying the continuous strip to the drum in an application direction perpendicular to said roller axis. The applicator roller is provided with retaining elements in the form of suction openings distributed over said roller body to retain the continuous strip to the roller body through suction.

### SUMMARY OF THE INVENTION

A disadvantage of the applicator roller as disclosed in WO 2022/177421 A1 is that the suction alone has proven to be insufficient to reliably retain the continuous strip to the applicator roller. In particular a leading end of the continuous strip has the tendency to continue in a straight line, instead of being sucked onto the applicator roller by the suction openings in the retaining surface. When the leading end is not reliably retained, its position on the applicator roller becomes undefined and, as a result, the application of said leading end, and potentially the continuous strip as a whole, onto the drum may be inaccurate, or the application may fail all together.

It is an object of the present invention to provide an applicator unit, a tire building device and a method for applying a continuous strip to a drum, wherein the accuracy of the application of the strip on the drum can be improved.

According to a first aspect, the invention provides an applicator unit for applying a continuous strip to a drum, wherein the applicator unit comprises an applicator roll with a roller body that is rotatable about a roll axis and that defines a retaining surface extending in a circumferential direction about the roll axis, wherein the applicator unit further comprises a retaining member for retaining the continuous strip in a retaining position on the retaining surface, wherein the retaining member is arranged for following the continuous strip in the retaining position on the retaining surface along a retaining arc of at least ten degrees about the roll axis as the roller body rotates about said roll axis.

By retaining the continuous strip to the retaining surface in the retaining position from the outside with the use of a retaining member, the applicator roll can more reliably retain said continuous strip through suction, in particular at the leading end thereof. Because the retaining member follows the continuous strip in the retaining position on the retaining surface as the roller body rotates, the continuous strip can be retained more securely to the applicator roller for at least a part of the rotation of the roller body. In particular, when initially the suction openings are not yet connected to a source of partial vacuum, the retaining member may already retain the continuous strip to the retaining surface until the respective suction openings are rotated into a position in which they are connected to a source of partial vacuum. The continuous strip can thus be retained by either the retaining member, the suction openings or both, according to a principle of never letting go of said continuous strip. As a result, the continuous strip can be received, positioned and/or held in position on the applicator roll more accurately. Consequently, the continuous strip can be applied to the drum more accurately.

Preferably, the retaining arc is at least twenty degrees, and preferably at least thirty degrees. The longer the retaining arc, the longer the continuous strip can be reliably retained to the applicator body.

In a further embodiment the applicator unit comprises a drive mechanism for moving the retaining member along the retaining arc. Hence, the movement of the retaining member can be controlled and/or automated.

Preferably, the drive mechanism is configured for moving the retaining member away from the retaining surface after moving the retaining member along the retaining arc. The retaining member can therefore make room for the subsequent interaction between the applicator roll and the drum.

In a further embodiment the drive mechanism comprises a first drive and a second drive for moving the retaining member along the retaining arc with a first vector component in a first drive direction and a second vector component in a second drive direction, respectively. The two vector components combined can generate a complex motion of the retaining member along a curvature matching the retaining arc.

Preferably, the first drive is arranged for moving the retaining member over a first stroke in the first drive direction, wherein the first stroke ends short of a midplane that coincides with the roll axis and that extends perpendicular to the first drive direction. Hence, movement of the retaining member can be limited to a position along the upper half of the applicator roll. This is the side of the applicator roll where the continuous strip is initially supplied from the extruder and also the side of the applicator roll where the continuous strip is transferred from the applicator roll onto the drum. Hence, it is sufficient for the retaining member to only move along this part of the applicator roll.

In a further embodiment the second drive is arranged for moving the retaining member solely in the second drive direction away from the retaining surface when the retaining member has reached the end of the first stroke. Hence, the retaining member can be moved away from the applicator roll to make room for the subsequent interaction between the applicator roll and the drum.

In a further embodiment the first drive direction is perpendicular to the roll axis. In other words, the retaining member can be moved in a plane perpendicular to said roll axis.

In a further embodiment the first drive direction is vertical or substantially vertical. Hence, the retaining member can be made to approach the applicator roll with a least a vector component in a vertical direction.

In a further embodiment the first drive and/or the second drive comprises a linear drive, preferably a pneumatic cylinder. The linear drives, and in particular the pneumatic cylinders, can be controlled to move the retaining member with a least a vector component in their respective drive directions when the retaining member has freedom of movement relative to the applicator roll to do so.

In a further embodiment the retaining member comprises a finger, a pressing roll or a pressing conveyor for contacting the continuous strip in the retaining position while following said continuous strip along a retaining arc. The finger, the pressing roll or the pressing conveyor can physically contact the continuous strip while following the continuous strip along the retaining arc, either through movement of the finger or the pressing roller as a whole along the retaining arc, or by designing the pressing conveyor such that its endless contact surface spans at least the retaining arc.

In a further embodiment the retaining member comprises a contact surface for contacting the continuous strip at the retaining position on the retaining surface, wherein the contact surface extends at an oblique contact angle to the first drive direction. The oblique contact angle can be chosen such that the retaining member can properly and/or reliably contact the continuous strip at both the start and the end of the retaining arc.

In another embodiment the applicator unit is further provided with a release element for releasing the continuous strip from the retaining member. The release element can prevent that the continuous strip remains stuck on the retaining member when said retaining member is moved away from the applicator roll at the end of the retaining arc.

Preferably, the release element is a blow-off channel provided in the retaining member. In this way, the continuous strip can be effectively separated from the retaining member and/or blown back onto the applicator roll if it is pulled with the retaining member in the second drive direction.

In another embodiment the applicator roll is further provided with a plurality of suction openings in the roller body for retaining the continuous strip to the retaining surface through suction,

In another embodiment the roller body is annular, wherein the applicator roller further comprises an inner member that is located concentrically within the roller body, wherein the roller body is rotatable about the inner member in the circumferential direction, wherein the inner member comprises a first chamber that is in air communication with the plurality of suction openings in a first circumferential section of the roller body, wherein the first chamber is connectable to a source of partial vacuum for retaining the continuous strip to the retaining surface at the first circumferential section.

Preferably, the retaining arc at least partially overlaps with the first circumferential section. In particular, the retaining arc overlaps for at least eighty percent with the first circumferential section. Hence, the continuous strip can be retained by the retaining member along at least a part of the circumferential section of the applicator roll that retains the continuous strip through suction.

In a further embodiment the inner member comprises a second chamber that is in air communication with the plurality of suction openings in a second circumferential section of the roller body, wherein the second chamber is connectable to a source of compressed air for blowing off the continuous strip from the retaining surface at the second circumferential section. The continuous strip can thus be blown off from the retaining surface to effectively transfer the continuous strip from the applicator roll onto the drum.

Preferably, the retaining arc stops short of or at the second circumferential section. Hence, the retaining member does not interfere with the blow off and/or unnecessarily press the continuous strip against the applicator roll at the position where the continuous strip should ultimately release from said applicator roll.

According to a second aspect, the invention provides a tire building device for applying a continuous strip to a drum, wherein the tire building device comprises an applicator unit according to any one of the embodiments of first aspect of the invention, wherein the tire building device further comprises an extruder for continuously extruding the continuous strip onto the applicator roll and the drum for continuously receiving the continuous strip from the applicator roll.

The tire building device comprises the applicator unit according to the first aspect of the invention and thus has the same technical advantages, which will not be repeated hereafter.

According to a third aspect, the invention provides a method for applying a continuous strip to a drum using an applicator unit according to any one of the embodiments of first aspect of the invention, wherein the method comprises the steps of:
rotating the applicator roll about the roll axis while retaining the continuous strip on the retaining surface through suction; and
retaining the continuous strip in the retaining position on the retaining surface with the retaining member while following said continuous strip with the retaining member in said retaining position on the retaining surface along the retaining arc as the roller body rotates about said roll axis.

The method relates to the practical implementation of the applicator unit according to the first aspect of the invention and thus has the same technical advantages, which will not be repeated hereafter.

In a preferred embodiment the method further comprises the step of:
moving the retaining member away from the retaining surface after moving the retaining member along the retaining arc.

In a further embodiment the method further
comprises the step of:
releasing the continuous strip from the retaining member after moving the retaining member along the retaining arc.

In a further embodiment the method further comprises the steps of:
continuously extruding the continuous strip onto the applicator roll; and
continuously applying the continuous strip on the drum with the applicator roll.

In the context of the present invention, the term ‘continuous’ is used to indicate a continuous process, using a continuous strip, in which the continuous strip is extruded and applied continuously and wound over several windings around the drum without cutting the continuous strip to length prior to each winding. Consequently, the length of the continuous strip exceeds the circumference of the drum and/or the applicator roll.

In a further embodiment the continuous strip has a leading end, wherein the continuous strip is retained in the retaining position on the retaining surface at the leading end. As mentioned earlier, the leading end may have the tendency to continue along a straight line instead of being retained to the applicator roll through suction. Hence, using the retaining member to retain the leading end can significantly improve the accuracy of the application of said leading end, and the rest of the continuous strip following said leading end, to the drum.

According to a fourth, unclaimed aspect, the invention provides an applicator unit for applying a continuous strip to a drum, wherein the applicator unit comprises an applicator roll with a roller body that is rotatable about a roll axis and that defines a retaining surface extending in a circumferential direction about the roll axis, wherein the applicator unit further comprises a retaining member for retaining the continuous strip in a retaining position on the retaining surface, wherein the retaining member is provided with an endless contact surface, in particular an endless belt, for contacting the continuous strip along a retaining arc of at least ten degrees about the roll axis as the roller body rotates about said roll axis.

The applicator unit according to the fourth aspect of the invention has substantially the same technical advantages as the previously discussed applicator unit. Moreover, the applicator unit according to the fourth aspect of the invention may be combined, mutatis mutandis, with any features or embodiments according to the previous aspects of the invention.

In one embodiment, the retaining member is a hugger belt.

In a further embodiment the endless contact surface is actively driven at the same or substantially the same speed as the continuous strip. Alternatively, the endless contact surface is passively moved as a result of friction between the continuous strip and the endless contact surface.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIGS. 1-6 show side views of a tire building device according to a first embodiment of the invention during the steps of a method for applying a strip on a drum using said tire building device; and

FIG. 7 shows a side view of an alternative tire building device according toa second embodiment of the invention during the steps of a method for applying a strip on a drum using said alternative tire building device.

### DETAILED DESCRIPTION OF THE INVENTION

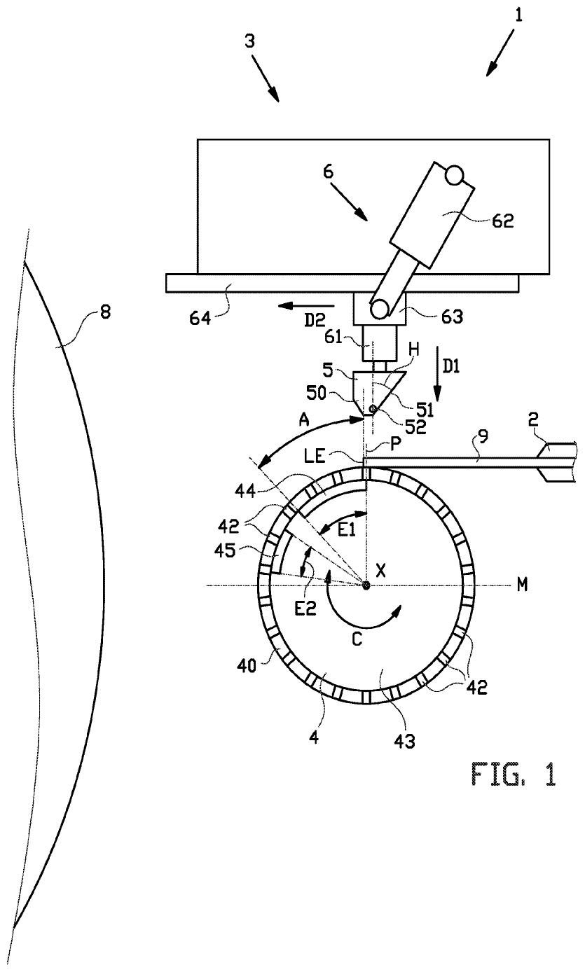

FIG. 1 shows a tire building device 1 according to a first embodiment of the invention, for applying a continuous strip 9 to a drum 8.

In this example, the continuous strip 9 is used for strip-winding a tire component (not shown) onto the drum 8. The drum 8 may therefore be a strip-winding drum. In strip-winding, the continuous strip 9 is wound in a plurality of windings around the drum 8 to form layers of the tire component, thereby gradually adding to the cross section of said tire component. The continuous strip 9 comprises or consists of elastomeric material, in particular rubber.

In the context of the present invention, the term ‘continuous strip’ is used to indicate a strip having a length that is sufficient to continuously apply and wind several windings of said strip around the drum 8 without cutting the continuous strip 9 to length prior to each winding. Consequently, the length of the continuous strip 9 exceeds the circumference of the drum 8.

The tire building device 1 comprises an extruder 2 for continuously extruding the continuous strip 9 and an applicator unit 3 for continuously applying the continuous strip 9 to the drum 8. In this example, the drum 8 is also considered a part of the tire building device 1. The drum 8 continuously receives the continuous strip 9 from the applicator unit 3.

As further shown in FIG. 1, the applicator unit 3 comprises an applicator roller or roll 4. The applicator roll 4 comprises a roller body 40. The roller body 40 is rotatable about a roll axis X. In this example, the roller body 40 is annular or ring shaped. The roller body 40 defines a retaining surface 41 extending in a circumferential direction C about the roll axis X. The retaining surface 41 has a circumference that is considerably smaller than the circumference of the drum 8.

The applicator roll 4 is further provided with a plurality of suction apertures or openings 42 in the roller body 40 for retaining the continuous strip 9 to the retaining surface 41 through suction.

The applicator roller 4 further comprises an inner member 43 that is located concentrically within or inside the roller body 40. The roller body 40 is rotatable about the inner member 43 in the circumferential direction C. The inner member 43 remains stationary and/or is fixed about the roller axis X.

The inner member 43 comprises a first chamber 44 that is in air communication with a group of the plurality of suction openings 42 in a first circumferential section E1 of the roller body 40. The first chamber 44 is connectable to a source of vacuum or partial vacuum for retaining the continuous strip 9 to the retaining surface 41 at the first circumferential section E1.

The inner member 43 further comprises a second chamber 45 that is in air communication with a group of the plurality of suction openings 42 in a second circumferential section E2 of the roller body 40. The second chamber 45 is connectable to a source of compressed air for blowing off the continuous strip 9 from the retaining surface 41 at the second circumferential section E2.

The applicator roll 4 as described above, including the roller body 40, the retaining surface 41, the suction openings 42, the inner body 43 and the chambers 44, 45, is similar or identical to the applicator roll and the corresponding parts as disclosed in WO 2022/177421 A1.

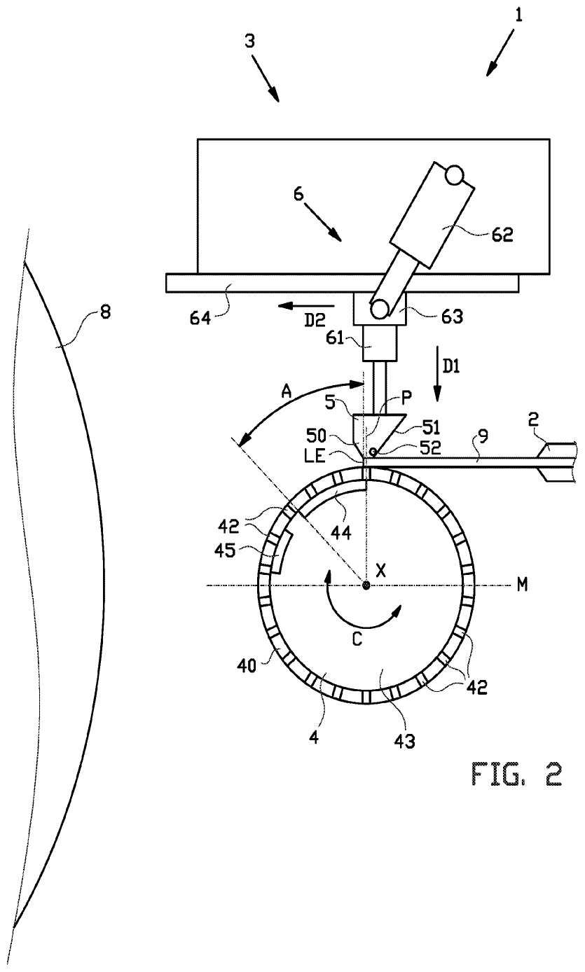

As shown in FIG. 2, the applicator unit 3 further comprises a pressing member or retaining member 5 for pressing and/or retaining the continuous strip 9 in a retaining position P on the retaining surface 41. In this example, the retaining member 5 is formed as a block or a finger for passively contacting the continuous strip 9. Alternatively, a pressing roller may be used.

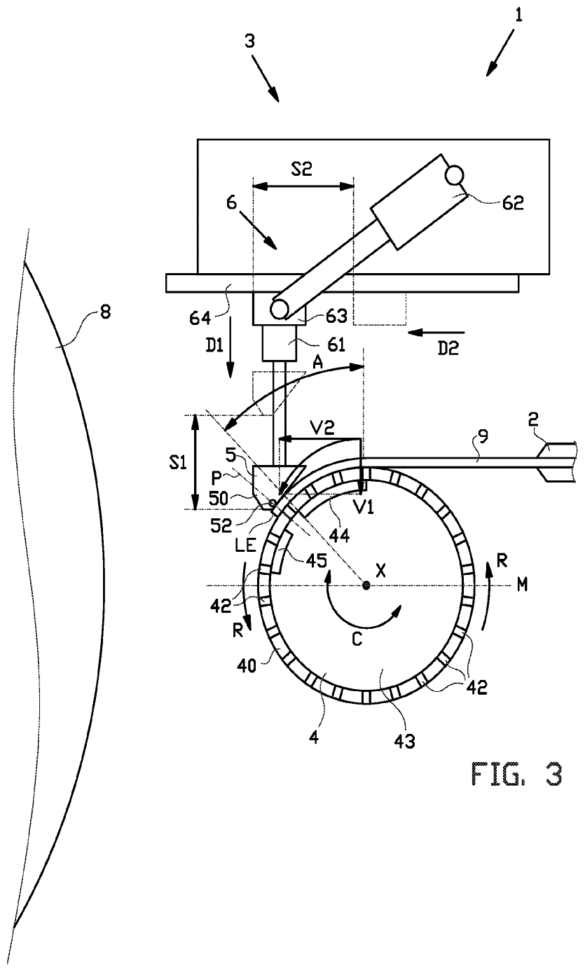

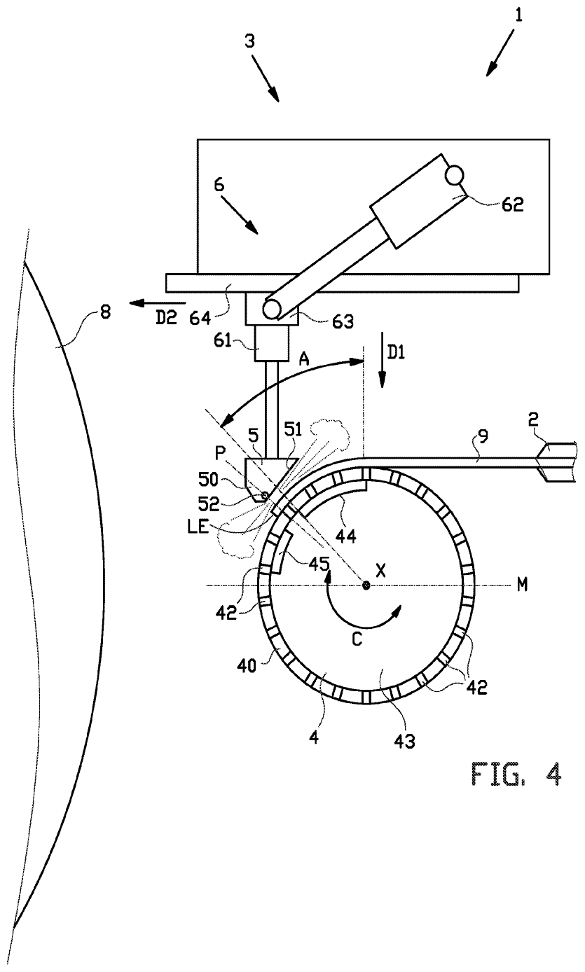

As seen by comparing FIGS. 2 and 3, the retaining member 5 is arranged for moving, tracking or following the continuous strip 9 in the retaining position P on the retaining surface 41 along a retaining arc A about the roll axis X. The retaining arc A starts at the angular position where the retaining member 5 first contacts the continuous strip 9, as shown in FIG. 2, and ends at the angular position about the roller axis X where the retaining member 5 leaves, disengages from or releases the continuous strip 9, as shown in FIG. 4. In this example, the retaining arc A extends along or spans more than forty degrees about the roller axis X.

In particular, the retaining arc A at least partially overlaps with the first circumferential section E1, for example over at least eighty percent. Moreover, in this example, the retaining arc A stops short of or at the second circumferential section E2.

As best seen in FIG. 1, the retaining member 5 comprises a finger body or a finger tip 50 with a contact surface 51 for contacting the continuous strip 9 at the retaining position P on the retaining surface 41. In this example, the contact surface 51 extends at an oblique contact angle H to a vertical plane. In particular, the oblique contact angle H is chosen such that the contact surface 51 can reliably contact the continuous strip 9 both at the start of the retaining arc A and at the end of said retaining arc A, while the orientation of the retaining member 5 relative to the applicator roll 4 remains the same or constant. In this example, the contact surface 51 extends at least at thirty degrees to the vertical plane, and preferably at least forty degrees.

As shown in FIG. 4, the applicator unit 3 is further provided with a release element 52 for releasing the continuous strip 9 from the retaining member 5. In this example, the release element 52 is a blow-off channel provided in the retaining member 5. The blow-off channel is connectable to a source of compressed air. Alternatively, a mechanical type release element may be used, for example a push-off member.

As shown in FIG. 1, the applicator unit 3 further comprises a drive assembly or mechanism 6 for moving the retaining member 5 along the retaining arc A. In particular, the drive mechanism 6 comprises a first drive 61 and a second drive 62 for moving the retaining member 5 along the retaining arc A with a first vector component V1 in a first drive direction D1 and a second vector component V2 in a second drive direction D2, respectively. The drives 61, 62 may thus cooperate to function as an XY drive. In other words, the drives 61, 62 are controlled in such a way that the vector components V1, V2 generated by the respective drives 61, 62 in the respective drive directions D1, D2 results in a combined or complex motion of the retaining member 5 along a curve matching the radius and/or curvature of the retaining arc A.

In this example, the first drive direction D1 is perpendicular to the roll axis X. In this specific embodiment, the first drive direction Dl is vertical or substantially vertical. Moreover, in this example, the second drive direction D2 is perpendicular to the first drive direction D1. Consequently, the second drive direction D2, in this specific embodiment, extends horizontally or substantially horizontally.

Note that the previously introduced oblique contact angle H of the contact surface 51 can alternatively be measured relative to the first drive direction D1.

As shown in FIG. 3, the first drive 61 is arranged for moving the retaining member 5 over a first stroke S1 in the first drive direction D1. Similarly, the second drive 62 is arranged for moving the retaining member 5 over a second stroke S2 in the second drive direction D2. The first stroke S1 stops or ends at a distance from or short of a midplane M that coincides with the roll axis X and that extends perpendicular to the first drive direction D1. In other words, the movement of the retaining member 5 is limited to a position at a distance from the midplane M, in particular at a level intersecting with the upper half of the applicator roll 4. In this specific example, the retaining member 5 bottoms out at the end of the first stroke S1 at a level somewhere halfway down the upper half of the applicator roll 4.

In this example, the first drive 61 is configured for acting on the retaining member 5 in or parallel to the first drive direction D1. The second drive 62 is arranged at an oblique angle to the second drive direction D2. The drive mechanism 6 further comprises a carriage 63 that supports or carries the first drive 61 and that is movable along a guide 64 in the second drive direction D2. The second drive 62 is coupled to the carriage 63 for moving the carriage along the guide 64, thereby converting the oblique action of the second drive 62 into a linear movement of the carriage 63 in the second drive direction D2.

When the retaining member 5 has reached or bottomed out at the end of the first stroke S1, the retaining member 5 can only be moved further in the second drive direction D2. The end of the second stroke S2 is chosen such that the retaining member 5 can be moved in the second drive direction D2 into a position spaced apart, clear or away from the retaining surface 41.

In this example, the first drive 61 and the second drive 62 comprises or are linear drives, in particular pneumatic cylinders. During the following movement of the retaining member 5 along the retaining arc A, the pneumatic cylinders are pressurized such that the retaining member 5 may be urged to automatically follow the retaining arc A in the first drive direction D1 and the second drive direction D2 when the retaining member 5 has freedom of movement relative to the applicator roll 4 to do so. Preferably, the pressure is kept constant, for example at one Bar.

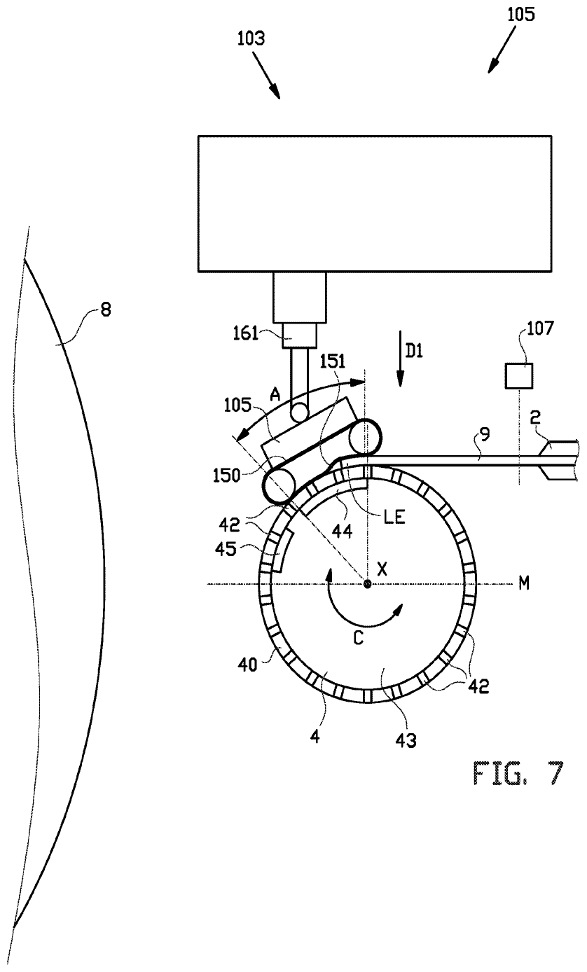

FIG. 7 shows an alternative tire building device 101 according to a second embodiment of the invention, that differs from the aforementioned tire building device 1 in that the applicator unit 103 is provided with a retaining member 105 that comprises a pressing conveyor, in particular a hugger belt 150. The retaining member 105 is provided with an endless contact surface 151, in particular an endless belt, for contacting the continuous strip 9 along the retaining arc A. The endless contact surface 151 may be actively driven at the same or substantially the same speed as the continuous strip 9 to follow the continuous strip 9 in the retaining position P on the applicator roller 4, or it may be passively moved together with the applicator roller 4 as a result of friction between the continuous strip 9 and the endless contact surface 151. The retaining member 105 can be moved towards and retracted away from the applicator roller 4 in the first drive direction D1 by the first drive 161, in particular a linear drive such as a pneumatic cylinder.

Moreover, the alternative tire building device 101 differs from the aforementioned tire building device 1 in that it is further provided with a sensor 107 for detecting the leading end LE of the continuous strip 9. Based on the detection of the leading end LE, the retaining member 105 can be moved down onto the leading end LE of the continuous strip 9 at the appropriate time, i.e. when the leading end LE enters the retaining arc A. The sensor 9 may be light sensor, a photoelectric sensor, an optical sensor, an imaging sensor or a height sensor. Alternatively, a temperature sensor may be used to detect an increase in heat indicative of the passing of the freshly extruded, hot leading end LE of the continuous strip 9. A temperature sensor may prevent false positives as a result of residual elastomeric material leaking from the extruder 2.

The sensor 107 may also be applied to the tire building device 1 in FIGS. 1-6 to control the first drive 61 to move the retaining member 5 towards the applicator roll 4.

A method for applying the continuous strip 9 to the drum 8 using the previously discussed applicator unit 3 will now be briefly elucidated with reference to FIGS. 1-6.

FIG. 1 shows the situation in which a length of the continuous strip 9 is freshly extruded and supplied to the applicator roll 4 until a leading end LE thereof is located at or in the retaining position P on the retaining surface 41. In this example, the retaining position P is initially located at the top of the applicator roll 4, referred to hereafter as the zero degree position about the roll axis X. The applicator unit 3 and the drum 8 have been spaced apart to provide room for movement of the retaining member 3 relative to the applicator roll 4. The drive mechanism 6 has been operated to move the retaining member 5 to a starting position at the start of the respective strokes S1, S2. The retaining member 5 is now above or vertically above the leading end LE of the continuous strip 9 in the first drive direction D1.

FIG. 2 shows the situation in which the first drive 61 has been controlled to move the retaining member 5 towards the applicator roll 4 in the first drive direction D1, until the retaining member 5 is in contact or abutment with the leading end LE of the continuous strip 9 in the first drive direction D1. The retaining member 5 now presses or retains the leading end LE of the continuous strip 9 to said retaining surface 41 in the retaining position P, such that the leading end LE can be reliably retained through suction to the retaining surface 41 during subsequent steps of the method.

FIG. 3 shows the situation in which the roller body 40 has been rotated, as shown with arrows R, while retaining the continuous strip 9 on the retaining surface 41 through suction, i.e. with the use of partial vacuum in the first chamber 44. Simultaneously, the drive mechanism 6 has been controlled to move the retaining member 5 along the retaining arc A, thereby following the rotation of the roller body 40 while retaining the leading end LE of the continuous strip 9 in the retaining position P to the retaining surface 41.

In FIG. 4, the retaining member 5 has reached the end of the first stroke S1 and can not be moved further in the first drive direction D1. In other words, the retaining member 5 has reached the end of the retaining arc A. The release element 52 has been activated to release the continuous strip 9 from the retaining member 5, while the second drive 62 has simultaneously started moving said retaining member 5 away from the retaining surface 41 in the second drive direction D2.

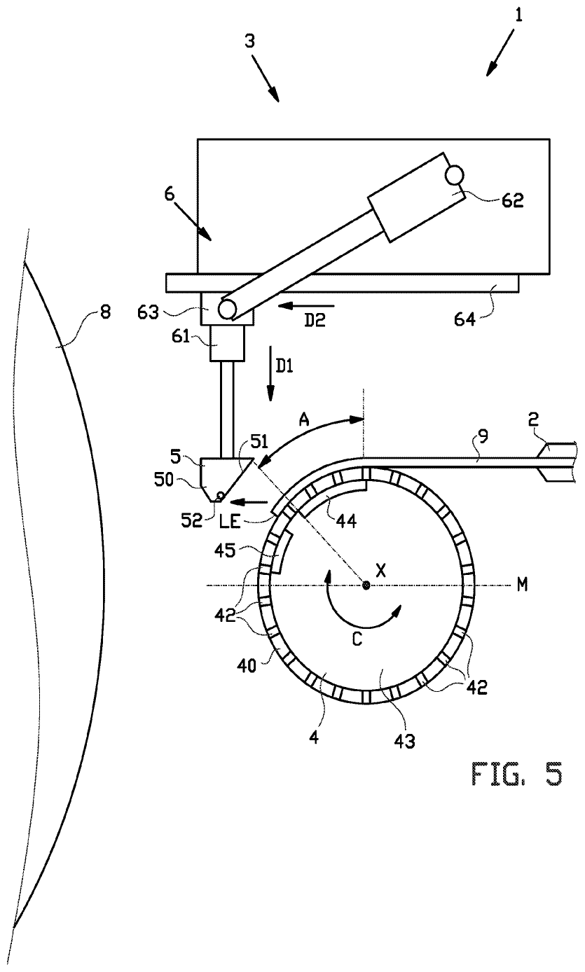

FIG. 5 shows the situation in which second drive 62 has moved the retaining member 5 clear and/or away from the applicator roll 4 in the second drive direction D2. The retaining member 5 may now be returned to its initial position of FIG. 1.

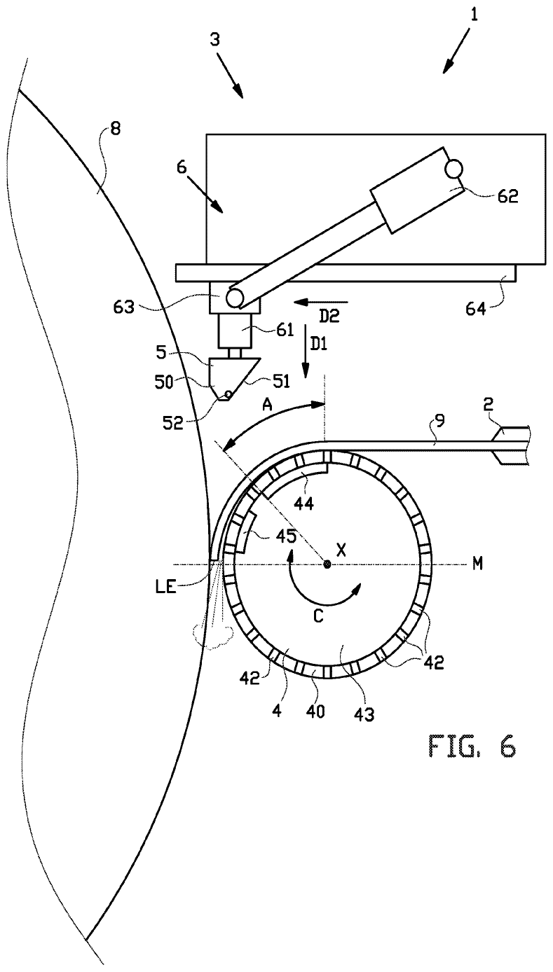

FIG. 6 shows the situation in which the first drive 61 has been reversed and/or retract to return the retaining member 5 to its initial position. The drum 8 is moved towards the applicator roll 4 to receive the leading end LE of the continuous strip 9 from said applicator roll 4. The extruder may now continuously extrude the continuous strip 9 and the applicator roll 4 may continuously apply said continuous strip 9 over several windings onto the drum 8 to form a tire component. During this process, the continuous strip 9 extends over only a part of the circumference of the applicator roll 4 before being applied onto the drum 8.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 tire building device
2 extruder
3 applicator unit
4 applicator roll
40 roller body
41 retaining surface
42 suction opening
43 inner member
44 first chamber
45 second chamber
5 retaining member
50 finger tip
51 contact surface
52 release element
6 drive mechanism
61 first drive
62 second drive
63 carriage
64 guide
8 drum
9 continuous strip
101 alternative tire building device
103 applicator unit
105 retaining member
150 hugger belt
151 contact surface
161 first drive
107 sensor
A retaining arc
C circumferential direction
D1 first drive direction
D2 second drive direction
E1 first circumferential section
E2 second circumferential section
H contact angle
LE leading end
M midplane
P retaining position
R rotation
S1 first stroke
S2 second stroke
X roll axis
V1 first vector component
V2 second vector component

1. An applicator unit for applying a continuous strip to a drum, wherein the applicator unit comprises an applicator roll with a roller body that is rotatable about a roll axis and that defines a retaining surface extending in a circumferential direction about the roll axis, wherein the applicator unit further comprises a retaining member for retaining the continuous strip in a retaining position on the retaining surface, wherein the retaining member is configured for following the continuous strip in the retaining position on the retaining surface along a retaining arc of at least ten degrees about the roll axis as the roller body rotates about said roll axis.

2. The applicator unit according to claim 1, wherein the retaining arc is at least twenty degrees.

3. The applicator unit according to claim 1, wherein the applicator unit comprises a drive mechanism configured for moving the retaining member along the retaining arc.

4. The applicator unit according to claim 3, wherein the drive mechanism is configured for moving the retaining member away from the retaining surface after moving the retaining member along the retaining arc.

5. The applicator unit according to claim 3, wherein the drive mechanism comprises a first drive and a second drive configured for moving the retaining member along the retaining arc with a first vector component in a first drive direction and a second vector component in a second drive direction, respectively.

6. The applicator unit according to claim 5, wherein the first drive is configured for moving the retaining member over a first stroke in the first drive direction, wherein the first stroke ends short of a midplane that coincides with the roll axis and that extends perpendicular to the first drive direction.

7. The applicator unit according to claim 5, wherein the second drive is configured for moving the retaining member solely in the second drive direction away from the retaining surface when the retaining member has reached the end of the first stroke.

8. The applicator unit according to claim 5, wherein the first drive direction is perpendicular to the roll axis.

9. The applicator unit according to claim 5, wherein the first drive direction is vertical.

10. The applicator unit according to claim 5, wherein the first drive or the second drive comprises a linear drive.

11. The applicator unit according to claim 1, wherein the retaining member comprises a finger, a pressing roll or a pressing conveyor configured for contacting the continuous strip in the retaining position while following said continuous strip along a retaining arc.

12. The applicator unit according to claim 5, wherein the retaining member comprises a contact surface configured for contacting the continuous strip at the retaining position on the retaining surface, wherein the contact surface extends at an oblique contact angle to the first drive direction.

13. The applicator unit according to claim 1, wherein the applicator unit is further provided with a release element configured for releasing the continuous strip from the retaining member.

14. The applicator unit according to claim 13, wherein the release element is a blow-off channel provided in the retaining member.

15. The applicator unit according to claim 1, wherein the applicator roll is further provided with a plurality of suction openings in the roller body configured for retaining the continuous strip to the retaining surface through suction.

16. The applicator unit according to claim 15, wherein the roller body is annular, wherein the applicator roller further comprises an inner member that is located concentrically within the roller body, wherein the roller body is rotatable about the inner member in the circumferential direction, wherein the inner member comprises a first chamber that is in air communication with the plurality of suction openings in a first circumferential section of the roller body, wherein the first chamber is connectable to a source of partial vacuum for retaining the continuous strip to the retaining surface at the first circumferential section.

17. The applicator unit according to claim 16, wherein the retaining arc at least partially overlaps with the first circumferential section.

18. The applicator unit according to claim 16, wherein the retaining arc overlaps for at least eighty percent with the first circumferential section.

19. The applicator unit according to claim 16, wherein the inner member comprises a second chamber that is in air communication with the plurality of suction openings in a second circumferential section of the roller body, wherein the second chamber is connectable to a source of compressed air for blowing off the continuous strip from the retaining surface at the second circumferential section.

20. The applicator unit according to claim 19, wherein the retaining arc stops short of or at the second circumferential section.

21. A tire building device for applying a continuous strip to a drum, wherein the tire building device comprises an applicator unit according to claim 1, wherein the tire building device further comprises an extruder configured for continuously extruding the continuous strip onto the applicator roll and the drum for continuously receiving the continuous strip from the applicator roll.

22. A method for applying a continuous strip to a drum using an applicator unit according to claim 1, wherein the method comprises the steps of:
rotating the applicator roll about the roll axis while retaining the continuous strip on the retaining surface through suction; and
retaining the continuous strip in the retaining position on the retaining surface with the retaining member while following said continuous strip with the retaining member in said retaining position on the retaining surface along the retaining arc as the roller body rotates about said roll axis.

23. The method according to claim 22, wherein the method further comprises the step of:
moving the retaining member away from the retaining surface after moving the retaining member along the retaining arc.

24. The method according to claim 22, wherein the method further comprises the step of:
releasing the continuous strip from the retaining member after moving the retaining member along the retaining arc.

25. The method according to claim 22, wherein the method further comprises the steps of:
continuously extruding the continuous strip onto the applicator roll; and
continuously applying the continuous strip on the drum with the applicator roll.

26. The method according to claim 22, wherein the continuous strip has a leading end, wherein the continuous strip is retained in the retaining position on the retaining surface at the leading end.
